(19) United States
(12) Patent Application Publication
(10) Pub. No.: US 2018/0213964 A1
(43) Pub. Date: Aug. 2, 2018

(54) STEAM GENERATOR AND ASSOCIATED STEAM COOKING SYSTEM

(71) Applicant: ILLINOIS TOOL WORKS INC., Glenview, IL (US)

(72) Inventors: Jeffrey L. Frock, Troy, OH (US); Timothy L. Cupp, Hillsboro, OH (US)

(21) Appl. No.: 15/886,238

(22) Filed: Feb. 1, 2018

Related U.S. Application Data
(60) Provisional application No. 62/453,695, filed on Feb. 2, 2017.

(51) Int. Cl. A47J 27/04; A47J 27/16; A23L 5/10

(52) U.S. Cl. CPC A47J 27/04; A47J 2027/043; A23L 5/13; A47J 27/16

(57) ABSTRACT

A steam generator includes a tank for holding water, and a heating system associated with the tank for heating water in the tank to produce steam, the heating system including a gaseous fuel burner that produces hot combustion gases. A steam superheater compartment receives combustion gases from the heating system and that includes a steam line therein that receives steam from the tank to provide heat exchange between hot combustion gases traveling through the compartment and steam traveling along the steam line. A tank feed water pre-heat system that receives combustion gases from the heating system and that includes a water feed line therein to provide heat exchange between hot combustion gases and water within the water feed line, wherein the water feed line is connected for delivery of pre-heated water to a water inlet of the tank.

### TECHNICAL FIELD

The present applications relates generally to steam generators, such as those used for commercial cooking equipment, and, more particularly, to a gas-fired steam generator with feed water preheat and/or superheated steam production.

### BACKGROUND

Steam cooking systems have been successfully employed by restaurants, hospitals and other food service operations to prepare quickly and conveniently large quantities of food. Many such cookers are used in high volume situations. Typical steam cooking systems include a steam boiler or generator that is used to generate steam. The steam generator may be heated by gaseous fluid combustion. The steam is delivered to a cooking chamber having food located therein. Often times, water is maintained at a pre-selected level within the steam cooker boiler by refilling the boiler with water as the water, in the form of steam, exits the boiler. Steam generators may also be used in connection with other commercial cooking equipment such as commercial ware wash machines.

It would be desirable to provide a steam generator with improved efficiency.

### SUMMARY

In one aspect, a steam generator includes a tank for holding water, and a heating system associated with the tank for heating water in the tank to produce steam, the heating system including a heat exchange tube arrangement within the tank and connected to receive hot combustion gases from a gaseous fuel burner. A steam superheat arrangement is formed at least in part by a heat exchange compartment along an external side of the tank, the heat exchange compartment connected to receive hot combustion gases and the heat exchange compartment including a steam carrying tube therewithin to provide heat exchange between hot combustion gases traveling through the heat exchange compartment and steam traveling along the steam carrying tube. A tank feed water pre-heat arrangement is associated with an exhaust stack of the steam generator, the tank including segment of a water feed line passing within the exhaust stack to provide heat exchange between hot combustion gases moving up the exhaust stack and water traveling along the segment, wherein the segment is connected for delivery of pre-heated water to a water inlet of the tank.

In another aspect, a steam cooking system includes a first steam cooking chamber including a first steam inlet, and a first outlet that is connected to a first steam vent stack; and a second steam cooking chamber including a second steam inlet, and a second outlet that is connected to a second steam vent stack. A first steam generator includes: a first tank for holding water; a first heating system associated with the tank for heating water in the first tank to produce steam, the first heating system including a first gaseous fuel burner that produces hot combustion gases; a first steam superheater compartment that receives combustion gases from the first heating system and that includes a first steam line therein that receives steam from the first tank to provide heat exchange between hot combustion gases traveling through the first compartment and steam traveling along the first steam line, wherein the first steam line is connected for delivery of steam to the first steam cooking chamber; and a first tank feed water pre-heat system that receives combustion gases from the first heating system and that includes a first water feed line therein to provide heat exchange between hot combustion gases and water within the first water feed line, wherein the first water feed line is connected for delivery of pre-heated water to a first water inlet of the first tank. A second steam generator includes: a second tank for holding water; a second heating system associated with the tank for heating water in the second tank to produce steam, the second heating system including a second gaseous fuel burner that produces hot combustion gases; a second steam superheater compartment that receives combustion gases from the second heating system and that includes a second steam line therein that receives steam from the second tank to provide heat exchange between hot combustion gases traveling through the second compartment and steam traveling along the second steam line, wherein the second steam line is connected for delivery of steam to the second steam cooking chamber; and a second tank feed water pre-heat system that receives combustion gases from the second heating system and that includes a second water feed line therein to provide heat exchange between hot combustion gases and water within the second water feed line, wherein the second water feed line is connected for delivery of pre-heated water to a second water inlet of the second tank.

In a further aspect, a steam generator includes a tank for holding water, and a heating system associated with the tank for heating water in the tank to produce steam, the heating system including a gaseous fuel burner that produces hot combustion gases. A steam superheater compartment receives combustion gases from the heating system and that includes a steam line therein that receives steam from the tank to provide heat exchange between hot combustion gases traveling through the compartment and steam traveling along the steam line. A tank feed water pre-heat system that receives combustion gases from the heating system and that includes a water feed line therein to provide heat exchange between hot combustion gases and water within the water feed line, wherein the water feed line is connected for delivery of pre-heated water to a water inlet of the tank.

### BRIEF DESCRIPTION OF THE DRAWINGS

FIG. 1 is a schematic depiction of a steam cooking system including two steam cooking chambers with respective steam generators;

FIGS. 2 and 3 show perspective views of an exemplary steam generator configuration;

FIG. 4 shows a perspective view of the steam generator with a portion of the tank wall removed; and

FIG. 5 shows a perspective view of the steam generator with side heat exchange compartment housing removed.

### DETAILED DESCRIPTION

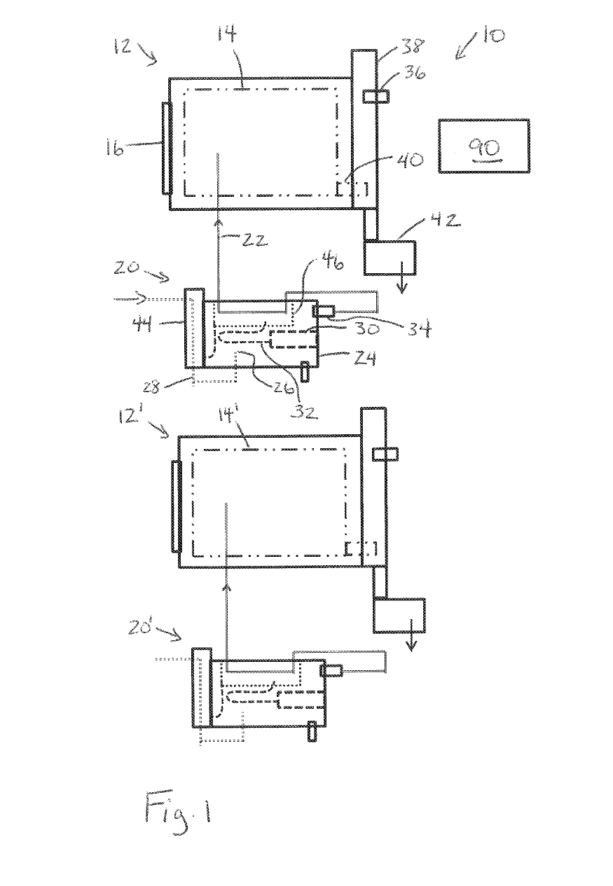

Referring to FIG. 1, a steam cooking system 10 is shown, which includes two steam cooking ovens 12, 12′ with respective steam cooking chambers 14. 14′ accessible via respective doors 16, 16′. The steam cooking ovens may be separate units or may, for example be incorporated into a single housing (e.g., stacked units). In the latter case a single controller 90 may be provided for controlling cooking operations of each oven, including operation of the steam generator 20, 20′ associated with each chamber 14, 14′. In this regard, a single user interface may be provided to control both ovens, or separate interfaces may be provided.

As used herein, the term controller is intended to broadly encompass any circuit (e.g., solid state, application specific integrated circuit (ASIC), an electronic circuit, a combinational logic circuit, a field programmable gate array (FPGA)), processor(s) (e.g., shared, dedicated, or group—including hardware or software that executes code), software, firmware and/or other control components, or a combination of some or all of the above, that carries out the control functions of the cooking system or the functions of steam generation). For the purpose of the following additional discussion of FIG. 1, the components and function associated with cooking oven 12 and its associated steam generator 20 are described, it being understood that similar components and function exist for cooking oven 12′ and its associated steam generator 20′.

As shown, steam generator 20 is connected via steam line 22 to feed steam to a steam inlet of the cooking chamber 14. The steam generator includes a tank 24 defining a water holding volume, with a water input 26 to which water can be fed (e.g., under control of a valve) via water input line 28. A gas-burner 30 is arranged within the tank 24 to produce combustion gases that traverse a combustion gas path 32 within the tank (e.g., through a heat-exchange tube) in order to heat water in the tank and produce steam. A steam outlet 34 of the tank connects to the steam line 22. In some cases a valve may be located along line 22 for steam delivery control, but in the exemplary system, no such valve is required.

In this regard, control of steam delivery to chamber 14 may be based upon control of steam production according to a temperature sensor 36 located in a steam vent stack 38 of the oven 12. As described in U.S. Patent Publication No. 2016/0157657, the controller 90 may utilize the indicated temperature from the sensor 36 to identify when steam is exiting the chamber via chamber outlet 40, in which case the gas burner 30 is modulated to reduce the input heat to the water (e.g., by controlling a valve to reduce the delivery of gaseous fuel to the burner), reducing steam production and thereby reducing steam delivery to the chamber. When the temperature indicated by temperature sensor 34 suitably drops, indicating steam is not exiting the chamber through the stack, operation of the burner 30 is modulated to produced more heat (e.g., by controlling a valve to increase gaseous fuel delivery to the burner) and thereby increase steam production and steam delivery to the chamber 14. The steam outlet 40 may also be associated with a drain path that includes a drain box 42 as shown (e.g., to drain condensate from within the chamber 14).

Notably, the water input line 28 traverses a path that places the water line in a heat exchange relationship with exhausting combustion gases from the steam generator (e.g., forming a tank feed water pre-heat arrangement for pre-heating feed water before it is delivered into the tank 24). Here the heat exchange relationship occurs in an exhaust stack 44 of the steam generator, but the heat exchange relationship could be elsewhere on the steam generator 20. Likewise, the steam line 22 traverses a path that places the steam line in a heat exchange relationship with exhausting combustion gases from the steam generator (e.g., forming a steam superheat arrangement that takes the temperature of the steam above 212° F. before the steam is delivered to the cooking chamber 14). Here, the heat exchange relationship occurs in a duct box 46 associated with a sidewall of the tank, where the combustion gas path 32 enters the duct and then passes back into the tank before reaching the exhaust stack 44, but the heat exchange relationship could be located elsewhere on the steam generator 20.

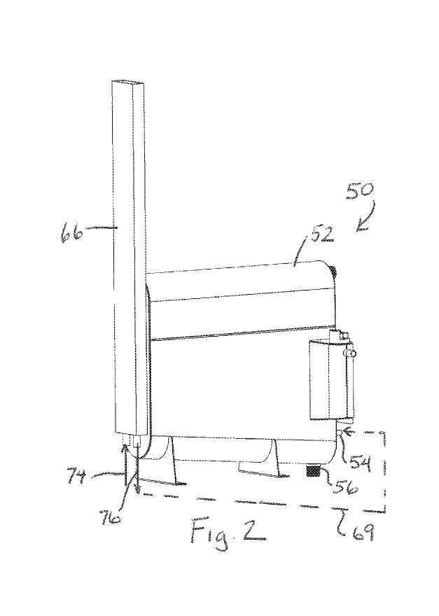

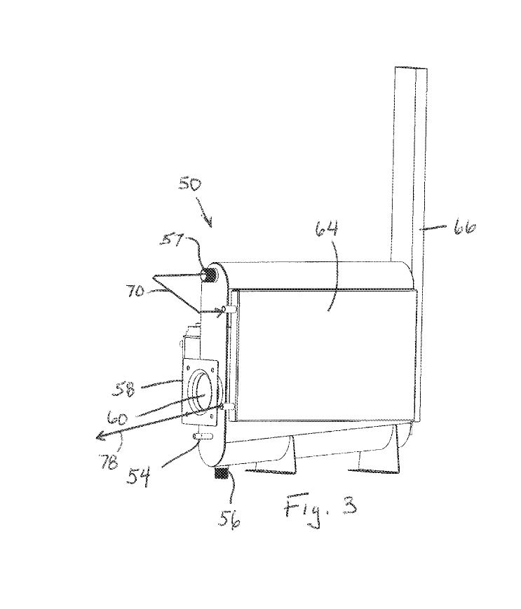

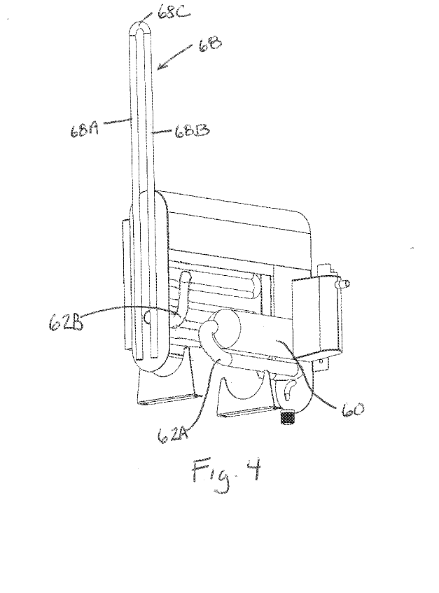

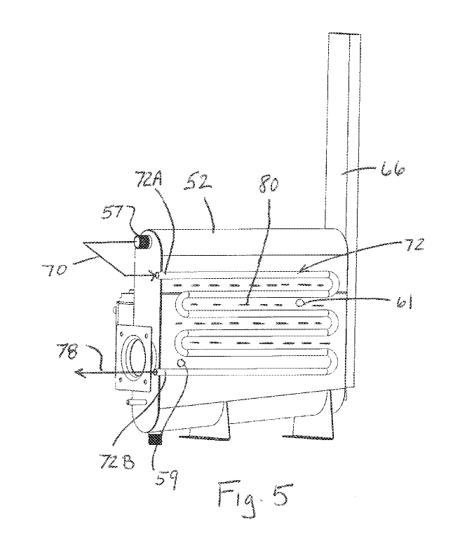

Referring now to FIGS. 2-5, a more detailed depiction of a steam generator 50 is shown, it being understood that generator 50 could be representative of schematically depicted steam generators 20 and 20′ of FIG. 1. Generator 50 includes tank 52 having a water infeed or inlet 54 to deliver fresh water into the tank, a water outlet 56 to drain water from the tank, and a steam outlet 57, where the bottom of the tank slopes downward toward drain outlet 56. The tank 52 includes a burner mount plate 58 that is connected with a burner tube 60 that extends into the tank and connects with combustion gas heat exchange tubing 62A that runs within the tank and to an opening 59 of the tank that feeds a side heat exchange box 64 mounted on the tank, with heat exchange tubing 62B running from another opening 61 of the tank to feed the combustion gases from the box 64 back into the tank and then to a combustion gas exhaust stack 66.

A fresh water feed tube includes a portion 68 that runs within the exhaust stack 66. In the illustrated embodiment portion 68 is substantially U-shaped with parallel segments 68A and 68B connected by a curved segment 68C. The fresh water tube then connects to the water inlet 54 as reflected schematically by dashed line 69. The steam outlet 57 is connected to deliver steam (e.g., via schematic path 70) to a heat exchange tube 72 that runs in a serpentine manner within the heat exchange box 64.

Thus, the steam generator configuration enhances efficiency of the system, because the combustion gases are used to not only heat the water in the tank 52 to generate steam, but also to (i) superheat the steam once generated (e.g., with superheating taking place in heat exchange box 64 and (ii) pre-heat the incoming replacement feed water to the tank (e.g., with the pre-heating taking place in the exhaust stack 66). In this regard, per arrow 74 the feed water enters the tube segment 68, picks up heat from the combustion gases in the stack 66 by heat transfer through the tube segment 68, and then exits per arrow 76 before being fed to the water inlet 54. Generated steam exits the tank 10 via steam outlet 57 and is delivered to an inlet end 72A of tube 72 that traverses side heat exchange box 64, so that the steam picks up additional heat from combustion gases in the side box 64 to produce superheated steam 78 which exits at outlet end 72B, which can be connected to a steam cooking chamber.

Baffle walls (e.g., represented by dashed lines 80) may be incorporated into the side compartment or box 64 if desired for controlled combustion gas routing in the side heat exchange box.

It is to be clearly understood that the above description is intended by way of illustration and example only, is not intended to be taken by way of limitation, and that other changes and modifications are possible. For example, the water pre-heat and the steam superheating could take place entirely within, or at least partially within, a common heat exchange space (e.g., both within the exhaust stack 66 or both in a side heat exchange box 64).

What is claimed is:

1. A steam generator, comprising:
a tank for holding water;
a heating system associated with the tank for heating water in the tank to produce steam, the heating system including a heat exchange tube arrangement within the tank and connected to receive hot combustion gases from a gaseous fuel burner;
a steam superheat arrangement formed at least in part by a heat exchange compartment along an external side of the tank, the heat exchange compartment connected to receive hot combustion gases and the heat exchange compartment including a steam carrying tube therewithin to provide heat exchange between hot combustion gases traveling through the heat exchange compartment and steam traveling along the steam carrying tube; and
a tank feed water pre-heat arrangement associated with an exhaust stack of the steam generator, the tank including segment of a water feed line passing within the exhaust stack to provide heat exchange between hot combustion gases moving up the exhaust stack and water traveling along the segment, wherein the segment is connected for delivery of pre-heated water to a water inlet of the tank.

2. The steam generator of claim 1 wherein the segment of the water feed line comprises a substantially U-shaped segment with upright parallel portions connected by a curved portion.

3. The steam generator of claim 2 wherein the steam line comprises a serpentine configuration within the heat exchange compartment.

4. The steam generator of claim 1 wherein the heat exchange compartment is located upstream of the exhaust stack, in a direction of combustion gas flow, such that hot combustion gases flow through the heat exchange compartment before flowing up the exhaust stack.

5. The steam generator of claim 4 wherein a heat exchange tube segment connects the heat exchange compartment to the exhaust stack to carry hot combustion gases from the heat exchange compartment to the exhaust stack, and the heat exchange tube segment extends within the tank.

6. A steam cooking oven including the steam generator of claim 1, comprising:
a steam cooking chamber having a steam inlet connected to receive superheated steam output by the steam generator of claim 1.

7. A steam cooking system, comprising:
a first steam cooking chamber including a first steam inlet, and a first outlet that is connected to a first steam vent stack;
a second steam cooking chamber including a second steam inlet, and a second outlet that is connected to a second steam vent stack;
a first steam generator including:
a first tank for holding water;
a first heating system associated with the tank for heating water in the first tank to produce steam, the first heating system including a first gaseous fuel burner that produces hot combustion gases;
a first steam superheater compartment that receives combustion gases from the first heating system and that includes a first steam line therein that receives steam from the first tank to provide heat exchange between hot combustion gases traveling through the first compartment and steam traveling along the first steam line, wherein the first steam line is connected for delivery of steam to the first steam cooking chamber; and
a first tank feed water pre-heat system that receives combustion gases from the first heating system and that includes a first water feed line therein to provide heat exchange between hot combustion gases and water within the first water feed line, wherein the first water feed line is connected for delivery of pre-heated water to a first water inlet of the first tank;
a second steam generator including:
a second tank for holding water;
a second heating system associated with the tank for heating water in the second tank to produce steam, the second heating system including a second gaseous fuel burner that produces hot combustion gases;
a second steam superheater compartment that receives combustion gases from the second heating system and that includes a second steam line therein that receives steam from the second tank to provide heat exchange between hot combustion gases traveling through the second compartment and steam traveling along the second steam line, wherein the second steam line is connected for delivery of steam to the second steam cooking chamber; and
a second tank feed water pre-heat system that receives combustion gases from the second heating system and that includes a second water feed line therein to provide heat exchange between hot combustion gases and water within the second water feed line, wherein the second water feed line is connected for delivery of pre-heated water to a second water inlet of the second tank.

8. The steam cooking system of claim 7 wherein:
the first steam cooking chamber and the second steam cooking chamber are within a common housing, the first steam cooking chamber accessible by a first door, the second steam cooking chamber accessible by a second door;
a controller is connected to control cooking operations of the first steam cooking chamber and the second steam cooking chamber, wherein the controller is connected to control operations of the first steam generator and the second steam generator independently of each other.

9. The steam cooking chamber of claim 8 wherein the controller is configured such that operation of the first gaseous fuel burner is modulated based upon sensed temperature within the first steam vent stack, and operation of the second gaseous fuel burner is modulated based upon sensed temperature within the second steam vent stack.

10. A steam generator, comprising:
a tank for holding water;
a heating system associated with the tank for heating water in the tank to produce steam, the heating system including a gaseous fuel burner that produces hot combustion gases;
a steam superheater compartment that receives combustion gases from the heating system and that includes a steam line therein that receives steam from the tank to provide heat exchange between hot combustion gases traveling through the compartment and steam traveling along the steam line; and
a tank feed water pre-heat system that receives combustion gases from the heating system and that includes a water feed line therein to provide heat exchange between hot combustion gases and water within the water feed line, wherein the water feed line is connected for delivery of pre-heated water to a water inlet of the tank.
